(19) United States
(12) Patent Application Publication
(10) Pub. No.: US 2014/0077045 A1
(43) Pub. Date: Mar. 20, 2014

(54) TESTING FIXTURE

(71) Applicant: ASKEY COMPUTER CORP., NEW TAIPEI CITY (TW)

(72) Inventor: Yi-Ju Chen, Taoyuan County (TW)

(73) Assignee: ASKEY COMPUTER CORP., NEW TAIPEI CITY (TW)

(21) Appl. No.: 13/741,333

(22) Filed: Jan. 14, 2013

(30) Foreign Application Priority Data
Sep. 18, 2012 (TW) 101134172

(51) Int. Cl. F16M 11/18

(52) U.S. Cl. CPC F16M 11/18
USPC 248/124.1

(57) ABSTRACT

A testing fixture is provided, which is adapted to adjust the position of an object to be tested and includes a first translation mechanism, a second translation mechanism and a height-adjusting mechanism. The first translation mechanism is able to move along a first axis, the second translation mechanism is disposed at the first translation mechanism and is able to move along a second axis perpendicular to the first axis, and the height-adjusting mechanism is disposed at the second translation mechanism and adapted to hold the object to be tested and is able to move along a third axis perpendicular to the first axis and the second axis.

### CROSS-REFERENCE TO RELATED APPLICATION

This application claims the priority benefit of Taiwan application serial no. 101134172, filed on Sep. 18, 2012. The entirety of the above-mentioned patent application is hereby incorporated by reference herein and made a part of this specification.

### BACKGROUND OF THE INVENTION

1. Field of the Invention

The invention generally relates to a testing fixture, and more particularly, to a testing fixture adapted to adjust and fix the position of an object to be tested.

2. Description of Related Art

With advances in science and technology, the appearance of the electronic device is developing toward the light-thin-short-small direction. Meanwhile, the kinds and the functions get increasingly diverse. Taking the smart phone as an example, in addition to the traditional communication function, it is also equipped a lens module on the smart phone to provide camera function.

For such sort of electronic device with a lens module, during the production process, in order to inspect whether the function of the lens module is normal and the mounting angle is correct, the operator usually holds the electronic device and makes shooting towards a target so as to judge out whether the shooting result is abnormal. However for each testing, it is hard to maintain the distance between the electronic device held by the operator's hand and the target and the angle towards the direction of the target strictly conformed, and slight difference may occur so as to lead to misjudgment and fail to effectively inspect and find out unqualified lens module.

### SUMMARY OF THE INVENTION

Accordingly, the invention is directed to a testing fixture able to make the distances and the angles between the different objects to be tested and the target conformed.

The invention provides a testing fixture adapted to adjust the position of an object to be tested and includes a first translation mechanism, a second translation mechanism and a height-adjusting mechanism. The first translation mechanism can move along a first axis, the second translation mechanism is disposed at the first translation mechanism and can move along a second axis perpendicular to the first axis, and the height-adjusting mechanism is disposed at the second translation mechanism and adapted to hold the object to be tested and move along a third axis perpendicular to the first axis and the second axis.

In an embodiment of the present invention, the first translation mechanism includes a first sliding portion along the first axis, and the second translation mechanism includes a second sliding portion corresponding to the first sliding portion.

In an embodiment of the present invention, the first sliding portion includes a rail and the second sliding portion includes a slider.

In an embodiment of the present invention, the first translation mechanism includes a first fixing part, and the first fixing part is adjustably located at the first sliding portion to fix the second sliding portion.

In an embodiment of the present invention, the first translation mechanism includes a first knob and a first gear connected to the first knob, the second translation mechanism includes a first rack, and the first gear is engaged with the first rack to finely adjust the relative position between the first translation mechanism and the second translation mechanism.

In an embodiment of the present invention, the second translation mechanism includes a plate and a carrying-stage, the plate has a second sliding portion and a third sliding portion, the second sliding portion and the third sliding portion are respectively disposed at two surfaces of the plate and the third sliding portion is along the second axis.

In an embodiment of the present invention, the carrying-stage includes a forth sliding portion corresponding to the third sliding portion, and the fourth sliding portion and the height-adjusting mechanism are respectively disposed at two opposite surfaces of the carrying-stage.

In an embodiment of the present invention, the third sliding portion includes a rail and the fourth sliding portion includes a slider.

In an embodiment of the present invention, the second translation mechanism includes a second fixing part, and the second fixing part is adjustably located at the third sliding portion to fix the fourth sliding portion.

In an embodiment of the present invention, one of the plate and the carrying-stage includes a second knob and a second gear connected to the second knob, the other one of the plate and the carrying-stage includes a second rack, and the second gear is engaged with the second rack to finely adjust relative position between the plate and the carrying-stage.

In an embodiment of the present invention, the height-adjusting mechanism includes a fixing base and a vertical slide, the fixing base is fixed at the second translation mechanism, the object to be tested is held at the vertical slide and the vertical slide can move along the third axis relatively to the fixing base.

In an embodiment of the present invention, the fixing base includes a fifth sliding portion along the third axis, and the vertical slide includes a sixth sliding portion corresponding to the fifth sliding portion.

In an embodiment of the present invention, the height-adjusting mechanism includes a third fixing part for fixing the relative position between the fixing base and the vertical slide.

In an embodiment of the present invention, one of the fixing base and the vertical slide includes a knob and a third gear connected to the knob, the other one of the fixing base and the vertical slide includes a third rack, and the third gear is engaged with the third rack to adjust the relative position between the fixing base and the vertical slide.

In an embodiment of the present invention, the height-adjusting mechanism includes a plurality of holes and a plurality of supporting parts, the supporting parts are detachably inserted into the partial holes to form an accommodation space with different sizes in response to the dimension of the object to be tested, and the accommodation space is adapted to hold the object to be tested.

In an embodiment of the present invention, the testing fixture further includes a connecting port disposed at the height-adjusting mechanism and adapted to be electrically connected to the object to be tested.

Based on the description above, the testing fixture of the invention uses the first translation mechanism, the second translation mechanism and the height-adjusting mechanism to adjust the three-dimensional position of the object to be tested and uses the first fixing part, the second fixing part and the third fixing part to fix the position of the object to be tested so as to maintain specific distance and angle between the object to be tested and the target and avoid the testing error caused by manually holding the object to be tested. In addition, the testing fixture of the invention can finely adjust the relative positions between the first translation mechanism, the second translation mechanism and the height-adjusting mechanism by turning the first knob, the second knob and the third knob to obtain a more accurate testing result.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a testing fixture according to an embodiment of the invention.

FIG. 2 is a top-view diagram of the first translation mechanism of the testing fixture in FIG. 1.

FIG. 3 is a side-view diagram of the second translation mechanism of the testing fixture in FIG. 1.

FIG. 4 is a schematic diagram of the height-adjusting mechanism of the testing fixture in FIG. 1.

FIG. 5 is a schematic diagram of a height-adjusting mechanism of a testing fixture according to another embodiment of the invention.

### DESCRIPTION OF THE EMBODIMENTS

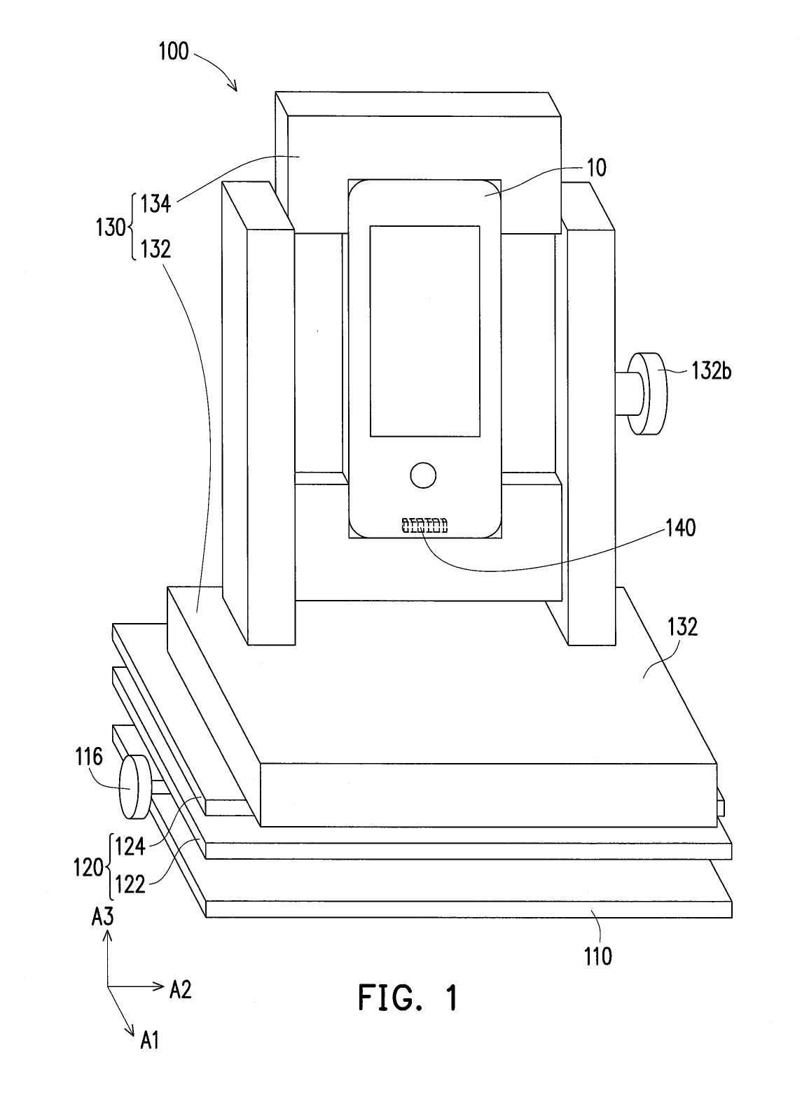

FIG. 1 is a schematic diagram of a testing fixture according to an embodiment of the invention. Referring to FIG. 1, a testing fixture 100 of the embodiment is adapted to adjust and fix the position of an object to be tested 10. In the embodiment, the object to be tested 10 can be a smart phone or a tablet computer, but the kind of the object to be tested 10 is not limited to.

The testing fixture 100 of the embodiment includes a first translation mechanism 110, a second translation mechanism 120 and a height-adjusting mechanism 130. The first translation mechanism 110 can move along a first axis A1, and the second translation mechanism 120 is disposed at the first translation mechanism 110 and can move along a second axis A2 perpendicular to the first axis A1. The height-adjusting mechanism 130 is disposed at the second translation mechanism 120 and adapted to hold the object to be tested 10 and move along a third axis A3 perpendicular to the first axis A1 and the second axis A2.

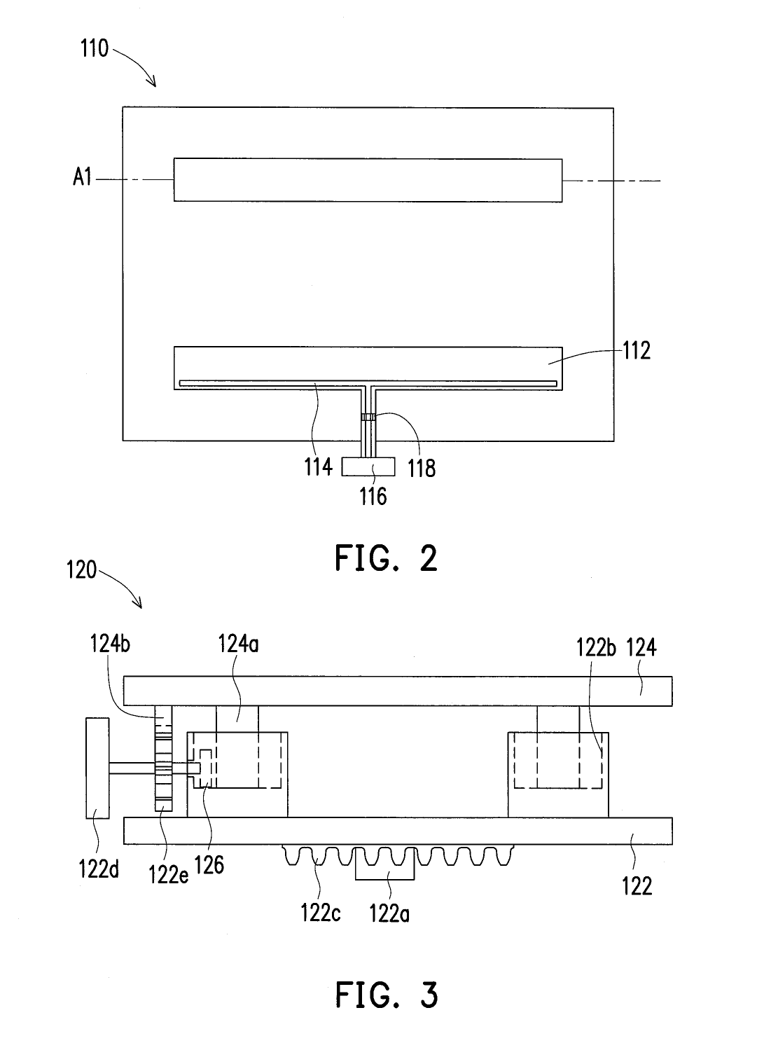

FIG. 2 is a top-view diagram of the first translation mechanism of the testing fixture in FIG. 1 and FIG. 3 is a side-view diagram of the second translation mechanism of the testing fixture in FIG. 1. Referring to FIGS. 2 and 3, the first translation mechanism 110 includes a first sliding portion 112 along the first axis A1, and the second translation mechanism 120 includes a second sliding portion 122a corresponding to the first sliding portion 112. In the embodiment, the first sliding portion 112 includes a rail and the second sliding portion 122a includes a slider, and the second sliding portion 122a is movably disposed in the first sliding portion 112 so that the second translation mechanism 120 can move along the first axis A1 relatively to the first translation mechanism 110.

As shown by FIG. 2, the first translation mechanism 110 includes a first fixing part 114 and a first knob 116 connected to the first fixing part 114. In the embodiment, the first fixing part 114 and the first knob 116 are integrally formed, and after pushing the first knob 116 exposed at the first translation mechanism 110 of the testing fixture 100 towards the direction of the first translation mechanism 110, the position of the first fixing part 114 in the first sliding portion 112 can be adjusted to clamp the second sliding portion 122a located in the first sliding portion 112.

In the embodiment, the first knob 116 can be a push-push mechanism so as to be fixed after pushing in the first knob 116. To adjust the relative position between the first translation mechanism 110 and the second translation mechanism 120, only pushing the first knob 116 once again is required to separate the first fixing part 114 from the second sliding portion 122a. The kind of the first knob 116 is certainly not limited to the above-mentioned.

In addition, the first translation mechanism 110 further includes a first gear 118 coaxial with the first knob 116. The second translation mechanism 120 includes a first rack 122c and the first gear 118 is engaged with the first rack 122c. By turning the first knob 116, there is a fine relative moving between the first gear 118 and the first rack 122c. The relative position between the first translation mechanism 110 and the second translation mechanism 120 can be finely adjusted.

As shown by FIG. 3, the second translation mechanism 120 includes a plate 122 and a carrying-stage 124. The plate 122 includes the second sliding portion 122a and a third sliding portion 122b. The second sliding portion 122a and the third sliding portion 122b are respectively disposed at two surfaces of the plate 122. The third sliding portion 122b is disposed along the second axis A2 and the carrying-stage 124 includes a fourth sliding portion 124a corresponding to the third sliding portion 122b. The fourth sliding portion 124a and the height-adjusting mechanism 130 are respectively disposed at the two opposite surfaces of the carrying-stage 124. In the embodiment, the third sliding portion 122b includes a rail and the fourth sliding portion 124a includes a slide. The fourth sliding portion 124a is movably disposed in the third sliding portion 122b to make the carrying-stage 124 able to move along the second axis A2 relatively to the plate 122.

In the embodiment, the second translation mechanism 120 includes a second fixing part 126, which is position-adjustable disposed at the third sliding portion 122b to fix the fourth sliding portion 124a. One of the plate 122 and the carrying-stage 124 includes a second knob 122d and a second gear 122e coaxial with the second knob 122d, while the other one of the plate 122 and the carrying-stage 124 includes a second rack 124b.

In the embodiment, the plate 122 includes the second knob 122d and the second gear 122e, and the carrying-stage 124 includes the second rack 124b. The second gear 122e is engaged with the second rack 124b to finely adjust the relative position between the plate 122 and the carrying table 124. In other embodiment, however, the carrying-stage 124 can include the second knob 122d and the second gear 122e, and the plate 122 includes the second rack 124b.

Since the second fixing part 126 and the second knob 122d are integrally formed in the embodiment, in order to fix the relative position between the plate 122 and the carrying-stage 124, the second knob 122d exposed at the second translation mechanism 120 should be pushed towards the second translation mechanism 120 (i.e., the right position in FIG. 2) so as to adjust the position of the second fixing part 126 in the third sliding portion 122b to hold the fourth sliding portion 124a in the third sliding portion 122b. In addition, to finely adjust the relative position between the plate 122 and the carrying table 124, the second knob 122d can be turned so that there is a relative moving between the second gear 122e and the second rack 124b to finely adjust the relative position between the plate 122 and the carrying table 124.

The second knob 122d of the embodiment can be a push-push mechanism. When pushing in the second knob 122d, the position thereof is fixed; when pressing the second knob 122d once again, the second fixing part 126 would be separated from the fourth sliding portion 124a. The kind of the second knob 122d certainly is not limited to the above-mentioned.

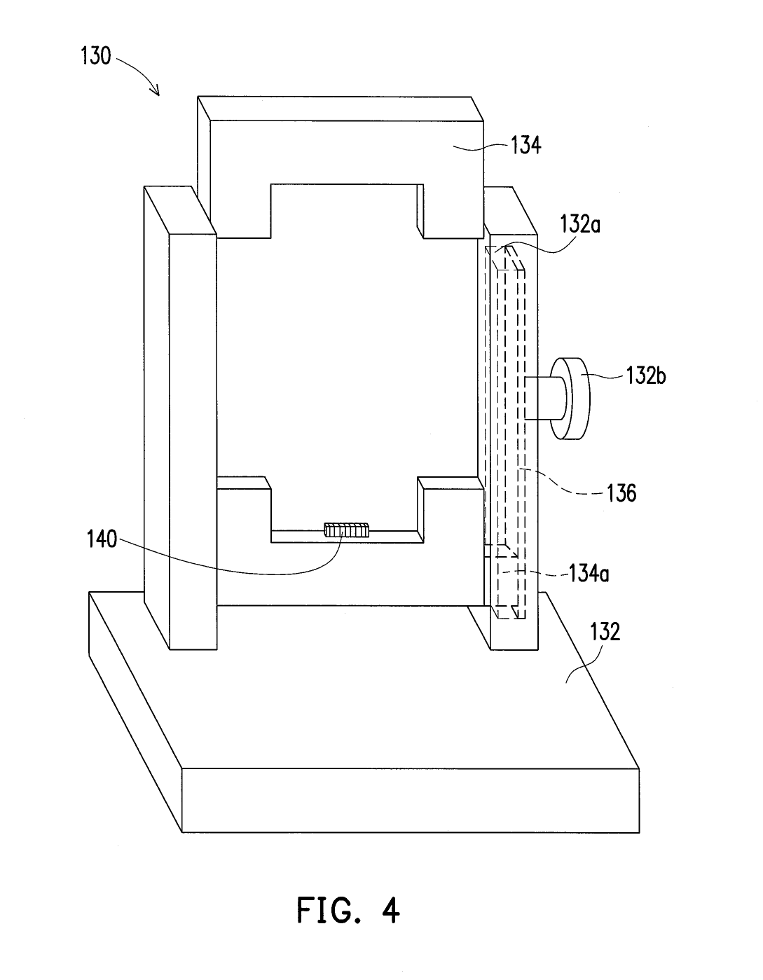

FIG. 4 is a schematic diagram of the height-adjusting mechanism of the testing fixture in FIG. 1. Referring FIG. 4, the height-adjusting mechanism 130 of the embodiment includes a fixing base 132 and a vertical slide 134, the fixing base 132 is fixed at the carrying-stage 124 of the height-adjusting mechanism 130, and the object to be tested 10 can be held at the vertical slide 134. The vertical slide 134 can move relatively to the fixing base 132 along the third axis A3, so that the object to be tested 10 placed on the vertical slide 134 can change the position thereof by adjusting the first translation mechanism 110, the second translation mechanism 120 and the height-adjusting mechanism 130.

As shown by FIG. 4, the fixing base 132 includes a fifth sliding portion 132a disposed along the third axis A3, and the vertical slide 134 includes a sixth sliding portion 134a corresponding to the fifth sliding portion 132a. In the embodiment, the fifth sliding portion 132a includes a rail and the sixth sliding portion 134a includes a slider. The sixth sliding portion 134a is movably disposed at the fifth sliding portion 132a to make the vertical slide 134 able to move relatively to the fixing base 132 along the third axis A3. The moving way of the vertical slide 134 relative to the fixing base 132 is certainly not limited to the above mentioned.

The height-adjusting mechanism 130 of the embodiment further includes a third knob 132b and a third fixing part 136. The third fixing part 136 is position-varied located in the fifth sliding portion 132a, and the third knob 132b and the third fixing part 136 are integrally formed. In order to fix the relative position between the vertical slide 134 and the fixing base 132, the third knob 132b exposed at the height-adjusting mechanism 130 is pushed towards the height-adjusting mechanism 130 (i.e., the left position of FIG. 4) and the sixth sliding portion 134a located in the fifth sliding portion 132a is clamped so as to fix the relative position between the vertical slide 134 and the fixing base 132.

In the embodiment, the third knob 132b can be a push-push mechanism. When pushing the third knob 132b, the position thereof is fixed. In order to adjust the relative position between the vertical slide 134 and the fixing base 132, the third knob 132b should be pressed once again to separate the third fixing part 136 from the sixth sliding portion 134a. The kind of the third knob 132b certainly is not limited to the above-mentioned, and the fixing way of the fixing base 132 and the vertical slide 134 is not limited to the above mentioned as well.

In other embodiments, the third fixing part 136 can be a screw, and a plurality of through holes (not shown) are disposed on the fixing base 132 of the height-adjusting mechanism 130 along the third axis A3 and a plurality of thread holes (not shown) are disposed on the vertical slide 134 along the third axis A3. After moving the vertical slide 134 to a required position relative to the fixing base 132, the third fixing part 136 goes through the fixing base 132 and is fixed at one of the thread holes of the vertical slide 134 so that the relative position between the vertical slide 134 and the fixing base 132 is fixed. The fixing way of the fixing base 132 and the vertical slide 134 is certainly not limited to the above mentioned.

In response to different sizes of the object to be tested 10, in the testing fixture 100 of the embodiment, the height-adjusting mechanism 130 is detachably disposed at the carrying-stage 124 of the second translation mechanism 120 so as to replace suitable height-adjusting mechanisms 130 able to accommodate the objects to be tested 10 in different sizes. For example, for an object to be tested 10 of smart phone, the height-adjusting mechanism 130 can employ a vertical slide 134 with a smaller accommodation space, while for an object to be tested 10 of tablet computer, the height-adjusting mechanism 130 can adopt a vertical slide 134 with a larger accommodation space. The way for the testing fixture 100 to hold the object to be tested 10 is certainly not limited to the above mentioned.

In the embodiment, the testing fixture 100 further includes a connecting port 140 disposed at the vertical slide 134 of the height-adjusting mechanism 130 and adapted to be electrically connected to the object to be tested 10 via one end thereof. Another end of the connecting port 140 can be connected to a power source or an electronic device (for example, a computer). The connecting port 140 is used to provide the object to be tested 10 with power or for information communication between the electronic device and the object to be tested 10.

The testing fixture 100 of the embodiment adjusts the three-dimensional position of the object to be tested 10 through the first translation mechanism 110, the second translation mechanism 120 and the height-adjusting mechanism 130, and fixes the position of the object to be tested 10 through the first fixing part 114, the second fixing part 126 and the third fixing part 136. For example, in order to test the function of the lens module in a smart phone or a tablet computer, the object to be tested 10 is placed on the testing fixture 100 so as to adjust the distance between the object to be tested 10 and the target (for example, a shooting subject). As long as the angle between the testing fixture 100 and the target is fixed, the angle between the object to be tested 10 and the target is fixed as well. In this way, the slight unconformities one testing time to another of the distance and angle for manually holding the object to be tested 10 and the errors caused by the unconformities can be avoided, which results in more accurate testing result.

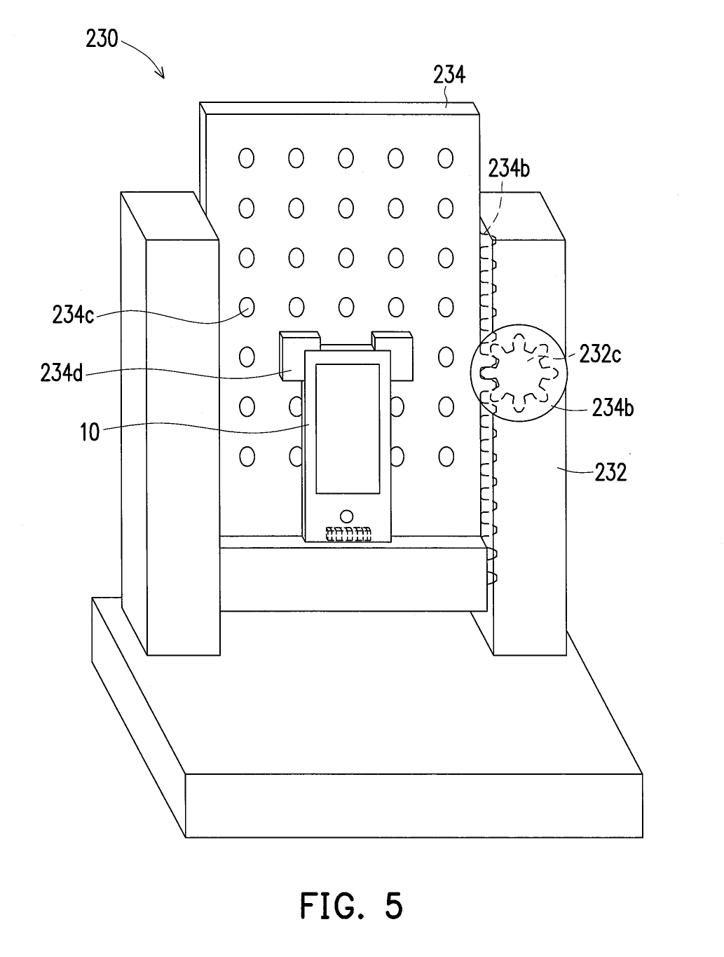

FIG. 5 is a schematic diagram of a height-adjusting mechanism of a testing fixture according to another embodiment of the invention. Referring to FIG. 5, the major difference of the height-adjusting mechanism 230 from the height-adjusting mechanism 130 of FIG. 4 rests in that in FIG. 5, one of the fixing base 232 and the vertical slide 234 includes a third knob 232b and a third gear 232c coaxial with the third knob 232b. The other one of the fixing base 232 and the vertical slide 234 includes a third rack 234b and the third gear 232c is engaged with the third rack 234b for adjusting the relative position between the vertical slide 234 and the fixing base 232.

In the embodiment, the fixing base 232 includes the third knob 232b and the third gear 232c and the vertical slide 234 includes the third rack 234b. In other embodiments however, the vertical slide 234 can include the third knob 232b and the third gear 232c, while the fixing base 232 includes the third rack 234b. Although the layout is upside down, as long as the third gear 232c and the third rack 234b can be ensured to be engaged with each other, the relative position between the vertical slide 234 and the fixing base 232 can be adjusted.

In addition, the vertical slide 234 of the height-adjusting mechanism 230 in the embodiment can include a plurality of holes 234c and a plurality of supporting parts 234d. The supporting parts 234d are detachably inserted into the partial holes 234c so as to form an accommodation space 234e suitable to hold the object to be tested 10 with different sizes. As a result, no need is required to replace different height-adjusting mechanism 230 to suit the object to be tested 10 with different dimensions and the usage becomes handier.

In summary, the testing fixture of the invention uses the first translation mechanism, the second translation mechanism and the height-adjusting mechanism to adjust the three-dimensional position of the object to be tested and uses the first fixing part, the second fixing part and the third fixing part to fix the position of the object to be tested so as to maintain specific distance and angle between the object to be tested and the target and avoid the testing error caused by manually holding the object to be tested. In addition, the testing fixture of the invention can finely adjust the relative positions between the first translation mechanism, the second translation mechanism and the height-adjusting mechanism by turning the first knob, the second knob and the third knob to obtain a more accurate testing result.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A testing fixture, adapted to adjust position of an object to be tested, comprising:
a first translation mechanism, moving along a first axis;
a second translation mechanism, disposed at the first translation mechanism and moving along a second axis perpendicular to the first axis; and
a height-adjusting mechanism, disposed at the second translation mechanism, adapted to hold the object to be tested and moving along a third axis perpendicular to the first axis and the second axis.

2. The testing fixture as claimed in claim 1, wherein the first translation mechanism comprises a first sliding portion along the first axis, and the second translation mechanism comprises a second sliding portion corresponding to the first sliding portion.

3. The testing fixture as claimed in claim 2, wherein the first translation mechanism comprises a first fixing part, and the first fixing part is adjustably located in the first sliding portion to fix the second sliding portion.

4. The testing fixture as claimed in claim 1, wherein the first translation mechanism comprises a first knob and a first gear connected to the first knob, the second translation mechanism comprises a first rack, and the first gear is engaged with the first rack to finely adjust relative position between the first translation mechanism and the second translation mechanism.

5. The testing fixture as claimed in claim 1, wherein the second translation mechanism comprises a plate and a carrying-stage, the plate has a second sliding portion and a third sliding portion, the second sliding portion and the third sliding portion are respectively disposed at two surfaces of the plate and the third sliding portion is along the second axis.

6. The testing fixture as claimed in claim 5, wherein the carrying-stage comprises a forth sliding portion corresponding to the third sliding portion, and the fourth sliding portion and the height-adjusting mechanism are respectively disposed at two opposite surfaces of the carrying-stage.

7. The testing fixture as claimed in claim 6, wherein the second translation mechanism comprises a second fixing part, and the second fixing part is adjustably located at the third sliding portion to fix the fourth sliding portion.

8. The testing fixture as claimed in claim 5, wherein one of the plate and the carrying-stage comprises a second knob and a second gear connected to the second knob, the other one of the plate and the carrying-stage comprises a second rack, and the second gear is engaged with the second rack to finely adjust relative position between the plate and the carrying-stage.

9. The testing fixture as claimed in claim 1, wherein the height-adjusting mechanism comprises a fixing base and a vertical slide, the fixing base is fixed at the second translation mechanism, the object to be tested is held at the vertical slide and the vertical slide moves along the third axis relatively to the fixing base.

10. The testing fixture as claimed in claim 9, wherein the fixing base comprises a fifth sliding portion along the third axis, and the vertical slide comprises a sixth sliding portion corresponding to the fifth sliding portion.

11. The testing fixture as claimed in claim 9, wherein the height-adjusting mechanism comprises a third fixing part for fixing relative position between the fixing base and the vertical slide.

12. The testing fixture as claimed in claim 9, wherein one of the fixing base and the vertical slide comprises a third knob and a third gear connected to the third knob, the other one of the fixing base and the vertical slide comprises a third rack, and the third gear is engaged with the third rack to adjust the relative position between the fixing base and the vertical slide.

13. The testing fixture as claimed in claim 1, wherein the height-adjusting mechanism comprises a plurality of holes and a plurality of supporting parts, the supporting parts are detachably inserted into the partial holes to form an accommodation space with different sizes in response to the dimension of the object to be tested, and the accommodation space is adapted to hold the object to be tested.

14. The testing fixture as claimed in claim 1, further comprising a connecting port disposed at the height-adjusting mechanism and adapted to be electrically connected to the object to be tested.
